(19) United States
(12) Patent Application Publication
(10) Pub. No.: US 2014/0071941 A1
(43) Pub. Date: Mar. 13, 2014

(54) METHODS AND APPARATUS FOR PCI SELECTION TO REDUCE INTERFERENCE FROM UNLOADED CELLS

(71) Applicant: QUALCOMM INCORPORATED, San Diego, CA (US)

(72) Inventors: Ahmed K. Sadek, San Diego, CA (US); Rajat Prakash, La Jolla, CA (US); Chirag Sureshbhai Patel, San Diego, CA (US)

(73) Assignee: QUALCOMM INCORPORATED, San Diego, CA (US)

(21) Appl. No.: 13/795,352

(22) Filed: Mar. 12, 2013

Related U.S. Application Data
(60) Provisional application No. 61/700,800, filed on Sep. 13, 2012.

(51) Int. Cl. H04W 8/26

(52) U.S. Cl. CPC H04W 8/26
USPC 370/331; 370/329; 370/328

(57) ABSTRACT

A method, an apparatus, and a computer program product for wireless communication are provided in connection with improving PCI selection and/or allocation so as to reduce interference from unloaded cells. In one example, a network entity is equipped to determine whether a cell is loaded or unloaded, and allocate a PCI from a common pool of PCIs to the cell when the cell is unloaded. In another example, a network entity is equipped to determine that a cell is to transition between an unloaded state and a loaded state, and use a first PCI from a common PCI pool associated with the cell in the unloaded state and a second PCI associated with the cell in the loaded state. In another example, a communications device is equipped to attempt to access a first cell associated with a first PCI which indicated that the first cell is unloaded.

The present application for patent claims priority to Provisional Application No. 61/700,800 entitled “METHODS AND APPARATUS FOR PCI SELECTION TO REDUCE INTERFERENCE FROM UNLOADED CELLS” filed Sep. 13, 2012, and assigned to the assignee hereof and hereby expressly incorporated by reference herein.

### BACKGROUND

1. Field

The present disclosure relates generally to communication systems, and more particularly, to improving physical cell identifier (PCI) selection and/or allocation so as to reduce interference from unloaded cells.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology.

Additionally, in communications systems that include multiple cells that may be associated with various power classes (e.g., heterogeneous networks), interference caused by pilot transmissions from neighbour cells may reduce the data rate that is achievable on a serving cell. The effect on the data rate of the serving cell may depend on the way the pilots of the neighbour and serving cell align with each other. For example, where the pilots align, the channel estimation on the serving cell becomes more difficult, leading to lower data rate. This loss can be reduced by using advanced receivers that can cancel the interference, but for normal receivers this loss can be significant. In an aspect, where there is strong interference, the channel estimation losses can be severe, leading to severe reduction in the data rate. In another example, where the pilots do not align, the channel estimation on the serving cell may not be degraded by the neighbour pilot, but the data from the serving cell may be degraded by interference from the neighbour cell pilot. In an aspect, where there is strong interference, all data tones from the serving cell that overlap with the interference can be lost.

As the density of cells increases and the interference becomes more severe, a technique is needed to reduce the reduction in data rate cause by interference from neighbour pilot transmissions. Additionally, as the demand for mobile broadband access continues to increase, there exists a need for further improvements in LTE technology. Preferably, these improvements should be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with improving PCI selection and/or allocation so as to reduce interference from unloaded cells. In one example, a network entity is equipped to determine whether a cell is loaded or unloaded, and allocate a PCI from a common pool of PCIs to the cell upon a determination that the cell is unloaded. In another example, a network entity is equipped to determine that a cell is to transition between an unloaded state and a loaded state, and use a first physical cell identifier (PCI) from a common PCI pool associated with the cell in the unloaded state and a second PCI from one of one or more PCI pools associated with the cell in the loaded state. In another example, a communications device is equipped to perform system measurements to identify one or more candidate cells, each of has a PCI associated with it, and attempt to access a first cell associated with a first PCI of the one or more candidate cells. In an aspect, the first PCI may be associated a first PCI pool indicating an unloaded state for the first cell.

According to related aspects, a method for improving PCI selection and/or allocation and reducing interference from unloaded cells is provided. The method can include determining whether a cell is loaded or unloaded. Moreover, the method may include allocating a PCI from a common pool of PCIs to the cell upon a determination that the cell is unloaded.

Another aspect relates to a communications apparatus enabled to improve PCI selection and/or allocation and reducing interference from unloaded cells. The communications apparatus can include means for determining whether a cell is loaded or unloaded. Moreover, the communications apparatus can include means for allocating a PCI from a common pool of PCIs to the cell upon a determination that the cell is unloaded.

Another aspect relates to a communications apparatus. The apparatus can include a processing system configured to determining whether a cell is loaded or unloaded. Moreover, the processing system may further be configured to allocate a PCI from a common pool of PCIs to the cell upon a determination that the cell is unloaded.

Still another aspect relates to a computer program product, which can have a computer-readable medium including code for determining whether a cell is loaded or unloaded. Moreover, the computer-readable medium can include code for allocating a PCI from a common pool of PCIs to the cell upon a determination that the cell is unloaded.

According to related aspects, a method for improving PCI selection and/or allocation and reducing interference from unloaded cells is provided. The method can include determining that a cell is to transition between an unloaded state and a loaded state. Moreover, the method may include using a PCI from a common PCI pool associated with the cell in the unloaded state and a second PCI from one of one or more PCI pools associated with the cell in the loaded state.

Another aspect relates to a communications apparatus enabled to improve PCI selection and/or allocation and reducing interference from unloaded cells. The communications apparatus can include means for determining that a cell is to transition between an unloaded state and a loaded state. Moreover, the communications apparatus can include means for using a PCI from a common PCI pool associated with the cell in the unloaded state and a second PCI from one of one or more PCI pools associated with the cell in the loaded state.

Another aspect relates to a communications apparatus. The apparatus can include a processing system configured to determine that a cell is to transition between an unloaded state and a loaded state. Moreover, the processing system may further be configured to use a PCI from a common PCI pool associated with the cell in the unloaded state and a second PCI from one of one or more PCI pools associated with the cell in the loaded state.

Still another aspect relates to a computer program product, which can have a computer-readable medium including code for determining that a cell is to transition between an unloaded state and a loaded state. Moreover, the computer-readable medium can include code for using a PCI from a common PCI pool associated with the cell in the unloaded state and a second PCI from one of one or more PCI pools associated with the cell in the loaded state.

According to related aspects, a method for improving PCI selection and/or allocation and reducing interference from unloaded cells is provided. The method can include performing, by a UE, system measurements to identify one or more candidate cells. In an aspect, a PCI may be associated with each of the one or more candidate cells. Moreover, the method may include attempting to access a first cell associated with a first PCI of the one or more candidate cells. In an aspect, the first PCI may be associated a first PCI pool indicating an unloaded state for the first cell.

Another aspect relates to a communications apparatus enabled to improve PCI selection and/or allocation and reducing interference from unloaded cells. The communications apparatus can include means for performing, by a UE, system measurements to identify one or more candidate cells. In an aspect, a PCI may be associated with each of the one or more candidate cells. Moreover, the communications apparatus can include means for attempting to access a first cell associated with a first PCI of the one or more candidate cells. In an aspect, the first PCI may be associated a first PCI pool indicating an unloaded state for the first cell.

Another aspect relates to a communications apparatus. The apparatus can include a processing system configured to perform system measurements to identify one or more candidate cells. In an aspect, a PCI may be associated with each of the one or more candidate cells. Moreover, the processing system may further be configured to attempt to access a first cell associated with a first PCI of the one or more candidate cells. In an aspect, the first PCI may be associated a first PCI pool indicating an unloaded state for the first cell.

Still another aspect relates to a computer program product, which can have a computer-readable medium including code for performing, by a UE, system measurements to identify one or more candidate cells. In an aspect, a PCI may be associated with each of the one or more candidate cells. Moreover, the computer-readable medium can include code for attempting to access a first cell associated with a first PCI of the one or more candidate cells. In an aspect, the first PCI may be associated a first PCI pool indicating an unloaded state for the first cell.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a network architecture.

FIG. 2 is a diagram illustrating an example of a heterogeneous access network.

FIG. 3 is a diagram illustrating an example of a network entity and user equipment in an access network.

FIG. 4 is a call flow diagram illustrating an example PCI selection scheme, according to an aspect.

FIG. 5 is a flow chart illustrating an example PCI allocation scheme, according to an aspect.

FIG. 6 is a flow chart diagram illustrating an example PCI selection scheme, according to an aspect.

FIG. 7 is a conceptual data flow diagram illustrating the data flow between different modules/means/components in an exemplary apparatus.

FIG. 8 is a diagram illustrating an example of a hardware implementation for an apparatus employing a processing system.

FIG. 9 is a flow chart diagram illustrating another example PCI selection scheme, according to an aspect.

FIG. 10 is a conceptual data flow diagram illustrating the data flow between different modules/means/components in an exemplary apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

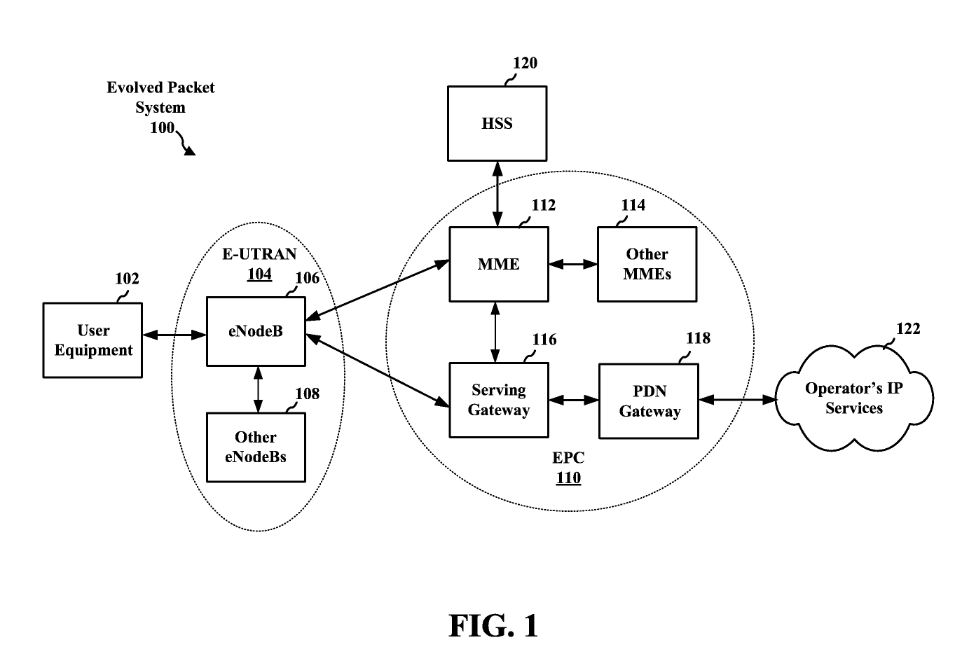

FIG. 1 is a diagram illustrating a LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

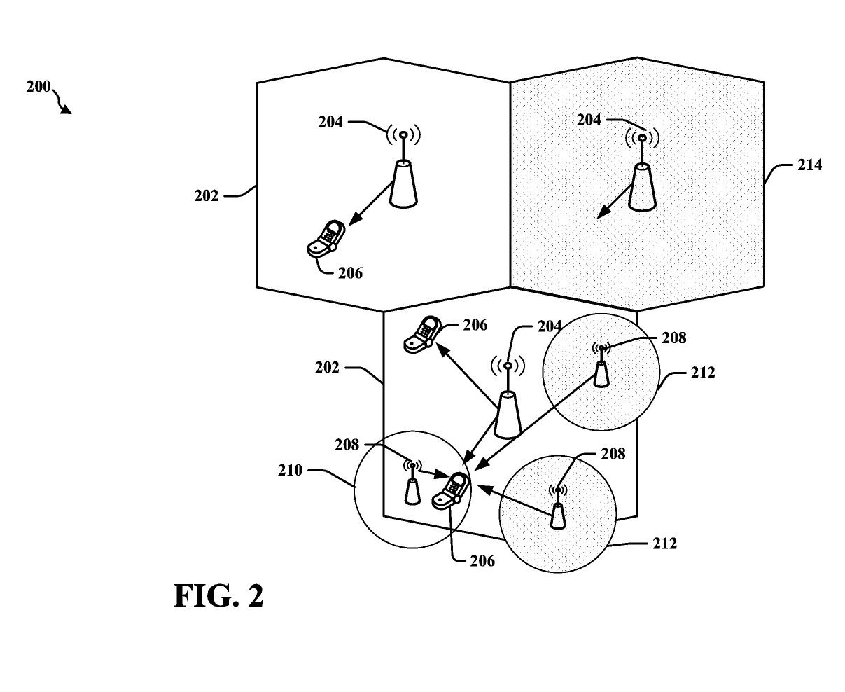

FIG. 2 is a diagram illustrating an example of an access network 200 in an LTE network architecture. In this example, the access network 200 is divided into a number of cellular regions (cells) 202, 214. One or more lower power class eNBs 208 may have cellular regions 210, 212 that overlap with one or more of the cells 202, 214. The lower power class eNB 208 may be a femto cell (e.g., home eNB (HeNB)), pico cell, micro cell, or remote radio head (RRH). The macro eNBs 204 are each assigned to a respective cell 202, 214 and are configured to provide an access point to the EPC 110 for all the UEs 206 in the cells 202, 214. There is no centralized controller in this example of an access network 200, but a centralized controller may be used in alternative configurations. The eNBs 204 are responsible for radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

In an aspect, one or more of the cells in the access network 200 may not be actively supporting a UE 206. As described herein, a cell that is not actively supporting a UE 206 may be referred to as an unloaded cell (e.g., 212, 214) and/or a cell in an unloaded state. Further, a cell that is actively supporting one or more UEs 206 may be referred to as a loaded cell (e.g., 202, 210) and/or a cell in a loaded state. In LTE three groups of 168 pilots each may be used, with each pilot in the group colliding with other pilots in the same group, while pilots in one group do not collide with pilots in another group. Thus, there are 168×3=504 total physical cell identifiers (PCIs) available.

In an operational aspect, unloaded cells (e.g., 212, 214) may be placed in the first group of pilots, while loaded cells (e.g., 202, 210) may be split (e.g., substantially equally) between the second and third groups of pilots. In such an aspect, the chance of colliding pilots being measured by a UE 206 decreases because UE 206 is associated with a loaded cell (e.g., 202, 210), and hence can be assured of non-colliding pilots from all unloaded cells (e.g., 212, 214).

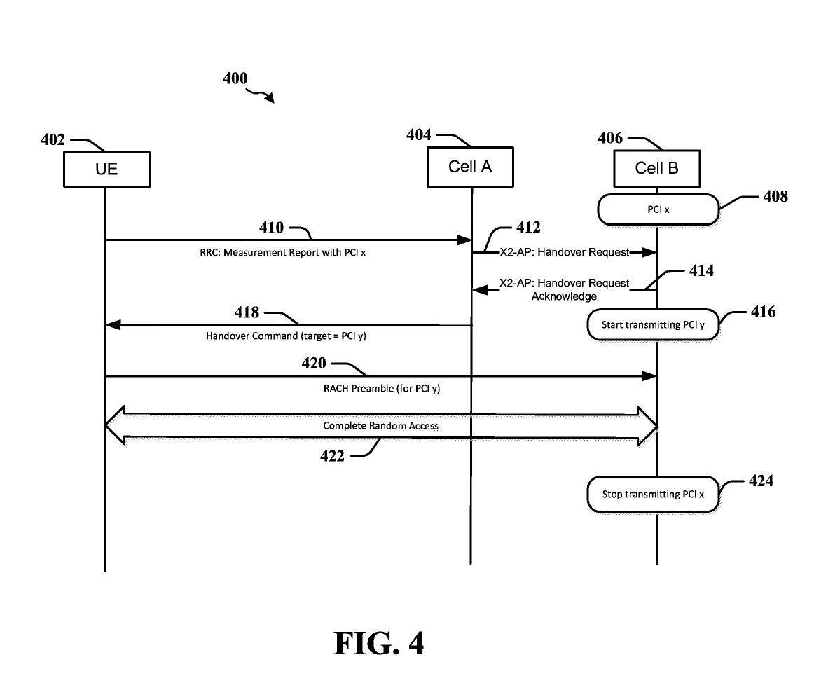

In another operational aspect, where a UE 206 attempts to access an unloaded cell (e.g., 212) and/or a cell (e.g., 202) ceases to serve any UEs, the cells may change their PCIs when transitioning between loaded and unloaded states. In such an aspect, the cell may gradually transition between the PCIs, e.g., when transitioning from PCI a to PCI b, the power for PCI a gradually ramps down while the power for PCI b gradually ramps up. Use of such a gradual process may allow switching of Idle UEs 206 camped on the cell, as the UEs 206 will reselect to PCI b during the ramping process. In another aspect, when transitioning from loaded to unloaded states, there may be no Connected UEs 206 on the cell, since the reason to make the transition is that no UEs 206 are connected, and as such the transition may be performed gradually and/or substantially instantaneously. In still another aspect when transitioning from an unloaded to a loaded state, a connected UE 206 may attempt to access a cell that is in an unloaded state as part of a handover process, as part of an connection initiation process, etc. Further description of various PCI allocation and/or selection processes is provided with reference to FIGS. 4, 5, 6, and 9.

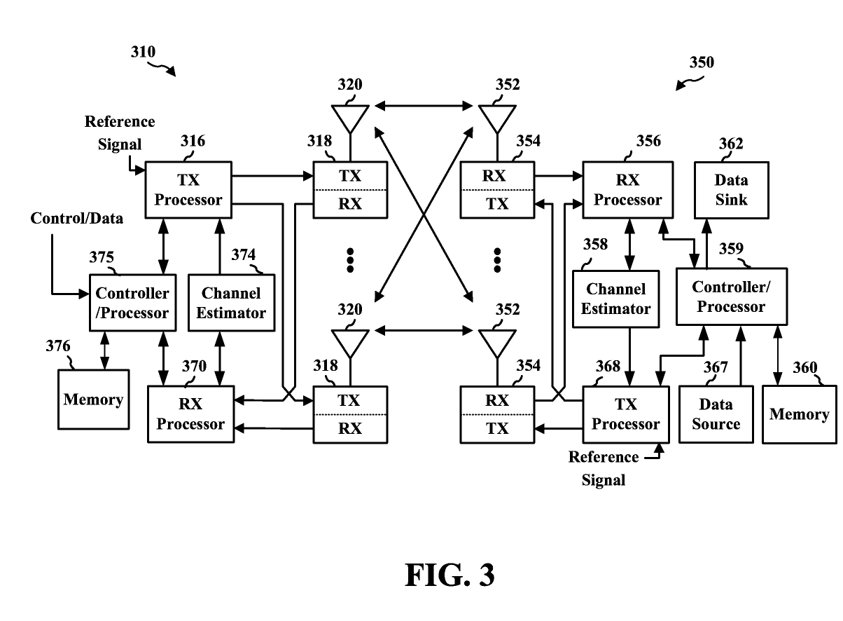

FIG. 3 is a block diagram of a network entity 310 (e.g., eNB, an MME, etc.) in communication with a UE 350 in an access network. In the DL, upper layer packets from the core network are provided to a controller/processor 375. The controller/processor 375 implements the functionality of the L2 layer. In the DL, the controller/processor 375 provides header compression, ciphering, packet segmentation and reordering, multiplexing between logical and transport channels, and radio resource allocations to the UE 350 based on various priority metrics. The controller/processor 375 is also responsible for HARQ operations, retransmission of lost packets, and signaling to the UE 350.

The transmit (TX) processor 316 implements various signal processing functions for the L1 layer (i.e., physical layer). The signal processing functions includes coding and interleaving to facilitate forward error correction (FEC) at the UE 350 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream is then provided to a different antenna 320 via a separate transmitter 318TX. Each transmitter 318TX modulates an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The RX processor 356 implements various signal processing functions of the L1 layer. The RX processor 356 performs spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the network entity 310. These soft decisions may be based on channel estimates computed by the channel estimator 358. The soft decisions are then decoded and deinterleaved to recover the data and control signals that were originally transmitted by the network entity 310 on the physical channel. The data and control signals are then provided to the controller/processor 359.

The controller/processor 359 implements the L2 layer. The controller/processor can be associated with a memory 360 that stores program codes and data. The memory 360 may be referred to as a computer-readable medium. In the UL, the controller/processor 359 provides demultiplexing between transport and logical channels, packet reassembly, deciphering, header decompression, control signal processing to recover upper layer packets from the core network. The upper layer packets are then provided to a data sink 362, which represents all the protocol layers above the L2 layer. Various control signals may also be provided to the data sink 362 for L3 processing. The controller/processor 359 is also responsible for error detection using an acknowledgement (ACK) and/or negative acknowledgement (NACK) protocol to support HARQ operations.

In the UL, a data source 367 is used to provide upper layer packets to the controller/processor 359. The data source 367 represents all protocol layers above the L2 layer. Similar to the functionality described in connection with the DL transmission by the network entity 310, the controller/processor 359 implements the L2 layer for the user plane and the control plane by providing header compression, ciphering, packet segmentation and reordering, and multiplexing between logical and transport channels based on radio resource allocations by the network entity 310. The controller/processor 359 is also responsible for HARQ operations, retransmission of lost packets, and signaling to the network entity 310.

Channel estimates derived by a channel estimator 358 from a reference signal or feedback transmitted by the network entity 310 may be used by the TX processor 368 to select the appropriate coding and modulation schemes, and to facilitate spatial processing. The spatial streams generated by the TX processor 368 are provided to different antenna 352 via separate transmitters 354TX. Each transmitter 354TX modulates an RF carrier with a respective spatial stream for transmission.

The UL transmission is processed at the network entity 310 in a manner similar to that described in connection with the receiver function at the UE 350. Each receiver 318RX receives a signal through its respective antenna 320. Each receiver 318RX recovers information modulated onto an RF carrier and provides the information to a RX processor 370. The RX processor 370 may implement the L1 layer.

The controller/processor 375 implements the L2 layer. The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover upper layer packets from the UE 350. Upper layer packets from the controller/processor 375 may be provided to the core network. The controller/processor 375 is also responsible for error detection using an ACK and/or NACK protocol to support HARQ operations.

FIGS. 4, 5, 6, and 9 illustrate various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 4 is a call flow diagram illustrating an access network 400 that includes a UE 402, Cell A 404, and Cell B 406.

At act 410, UE 402 may send a measurement report to Cell A 404 listing a strong PCI x that is associated with Cell B 406. At act 412, Cell B 406 may receive a handover request for the UE 402 from Cell A 404. At act 414, Cell B 406 may respond to Cell A 404 with an handover request acknowledgement. At act 416, Cell B 306 may start transmitting pilots for PCI y (e.g., with the same power as PCI x), while at act 418, Cell A 404, may send a handover command to UE 402 with the target identified using PCI y. At act 420, UE 404 sends a connection message (e.g., a handover message using the random access channel (RACH) with PCI y identified in the preamble). At act 422, UE 404 connects to cell B with PCI y. Thereafter, at act 424, Cell B 404 may gradually ramps down PCI x to zero power, and ramps up PCI y to normal operating power.

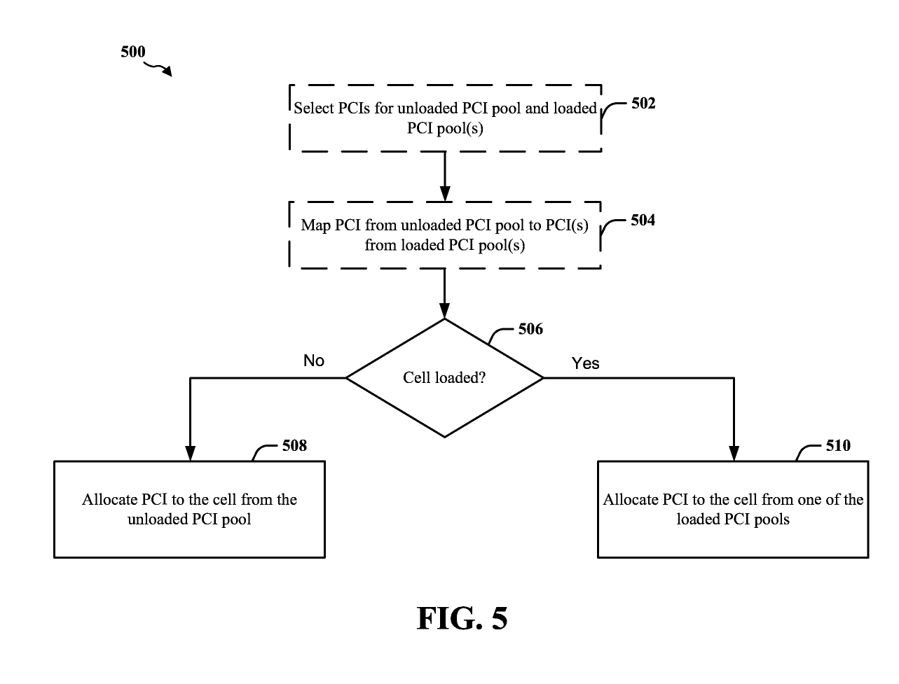

FIG. 5 is a flow chart 500 of a method of wireless communication. The method may be performed by a network entity (e.g., eNB, MME, etc.). In an aspect, PCIs may be allocated and/or selected based on whether the cell is loaded or unloaded. In such an aspect, in an LTE system that has three PCI groups, all unloaded cells may be placed in the first group (e.g., pool), while loaded cells may be split between the second and third groups (e.g., pools).

In an optional aspect, at block 502, the network entity may select PCIs to be assigned to a pool available for unloaded cells and one or more pools available for loaded cells. Such selection may be performed statically and/or dynamically. In an aspect, the selection may be performed by PCI allocation module 712. In an aspect in which the selection is performed statically, the network entity may use fixed and/or defined pools. For example, the first group of PCIs (e.g., which may include 168 PCIs) may be selected for the unloaded cell pool and each unloaded cell may select a PCI from the common pool based on one or more criterion associated with the neighbor cells. In one aspect, the criterion may include the PCI with minimum energy, a PCI with energy below a threshold, etc. In another aspect, the criterion may be based on increasing the minimum distance between two cells using the same PCI. In an aspect in which the selection is performed dynamically, the common pool selected for unloaded cells may be dynamic (e.g., its size can shrink or expand based on the number of unloaded cells). In an aspect, the dynamically selectable set of PCIs for unloaded cells may have a maximum size of the pool (e.g., the largest set may be fixed and/or defined). In an aspect, a superset of the common pool of PCIs available for unloaded cells may be defined as {1, 2, 3, . . . , N} where N is the maximum number of PCIs allocated to the common pool, for example N=168 and {1, 2, . . . , 168} may represent one group of the three groups of PCI. When an unloaded cell selects a PCI from the common pool it select the PCI with the least energy, with an energy below a threshold, and/or based on some other criteria. In another aspect, if multiple PCIs have the same lowest energy, or their energies are below the threshold, the cell may select the PCI with the smallest index out of {1, 2, . . . , N}. For example, if PCIs 10, 35, 60 satisfy the same selection criteria, the unloaded cell may select PCI with index 10. As such, the unloaded cell may occupy the PCI with lower indices in the set {1, 2, . . . , N} making the higher indices available for loaded cells. Additionally or in the alternative, a loaded cell can select its PCI from an available pool of PCIs. If multiple PCIs have the lowest energy or their energy is below the threshold, the loaded cell may select a PCI among those PCIs satisfying the selection criteria and that does not belong to the common pool {1, 2 . . . , N}. If on the other hand, only PCIs from the common pool satisfy the criteria, the loaded cell may select the PCI with the largest index. Using the above described dynamic approach, the size of the common pool may expand (up to a limit) and shrink based on the number of unloaded cells. Further, the approach may improve efficiency because as the number of loaded cells increase, PCIs with higher indices in the common pool may not be unused and as such wasted.

In another optional aspect, at block 504, the network entity may map PCI values associated with the pool available for unloaded cells to PCI values associated with the one or more pools available for loaded cells. Such mapping may be performed statically and/or dynamically. In an aspect in which the mapping is performed statically, the unloaded cells may use PCIs in a first group with 168 PCIs. Further, the loaded cells use PCIs in the second or third groups with 168 PCIs. For each PCI (x1) in the first group, a corresponding PCI y can be found by y1=x1+168 or y2=x1+168×2. This static mapping has the advantage that the neighbor relations table at neighboring cells need not be updated when a cell changes its PCI, as they implicitly know that (x1, y1 and y2) all belong to the same cell. Also, during PCI planning, to avoid reuse of the same PCI by neighbor cells, static mapping may prevent collisions from occurring due to changes to PCI because a new cell can select its PCI so as to avoid collisions with all cells currently using x1 in the vicinity, and also with all cells using y1 and y2 in the vicinity. In an aspect in which the mapping is performed dynamically, the cell may select a PCI y based on the local usage pattern of PCIs. For example, the radio environment may be scanned to determine which PCIs are being used by neighbors, and may backhaul signaling may be used to determine which PCIs are being used by neighbors of neighbors. As such, the PCI y may be selected by avoiding all the PCIs determined to be in the vicinity. In an aspect, the mapping may be performed by PCI mapping module 710.

At block 506, the network entity may determine whether a cell is loaded or unloaded. In an aspect, when a cell is not serving an active (e.g., connected) UE, the cell may be considered an unloaded cell. In an aspect, a reception module 704 may be configured to receive signals from one or more UEs 206 and/or one or more eNBs 204, 208. In another aspect, the determination may be performed by PCI allocation module 712.

If at block 506, the cell is determined not to be loaded, then at block 508, the cell may be allocated a PCI from the unloaded PCI pool. In an aspect, the allocation may be performed by PCI allocation module 712. In an aspect, the allocated PCI may be communicated to the cell 204, 208 using transmission module 708.

By contrast, if at block 506, the cell is determined to be loaded, then at block 510, the cell may be allocated a PCI from one of the loaded PCI pools. In an aspect, the allocation may be performed by PCI allocation module 712. In an aspect, the allocated PCI may be communicated to the cell 204, 208 using transmission module 708.

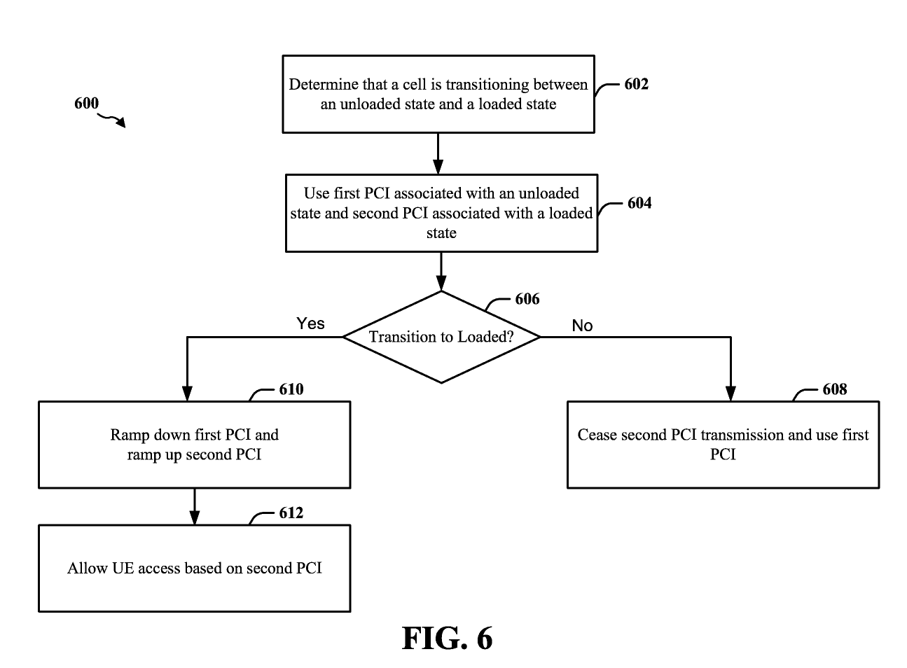

FIG. 6 is a flow chart 600 of a method of wireless communication. The method may be performed by a network entity (e.g., eNB, MME, etc.). In an aspect, PCIs may be allocated and/or selected based on whether the cell is loaded or unloaded. In such an aspect, in an LTE system that has three PCI groups, all unloaded cells may be placed in the first group (e.g., pool), while loaded cells may be split between the second and third groups (e.g., pools). In an aspect, the determination may be performed by PCI transition module 706.

At block 602, the network entity may determine that a cell is to transition between an unloaded state and a loaded state. At block 604, the network entity may use a first physical cell identifier (PCI) from a common PCI pool associated with the cell in the unloaded state and a second PCI from one of one or more PCI pools associated with the cell in the loaded state. In an aspect, the determination may be performed by PCI transition module 706.

At block 606, the network entity may determine whether the cell is switching by an unloaded state to a loaded state or from a loaded state to an unloaded state. In an aspect, the determination may be performed by PCI transition module 706.

If at block 606, the network entity determines that the cell is transitioning from a loaded state to an unloaded state, then at block 608, the cell may cease using the second PCI and transition to using the first PCI. In an aspect, the network entity may use transmission module 708 to transmit signalling including the first PCI.

By contrast, if at block 606, the network entity determines that the cell is transitioning from an unloaded state to a loaded state, then at block 610, the network entity may ramp downwards power associated with signals from the first PCI while ramping upwards power associated with signals from the second PCI. In an aspect, the network entity may use transmission module 708 to transmit signalling including the first and second PCI. Thereafter, at block 612, a UE may access the cell based on the second PCI.

With respect to blocks 610 and 612, a cell may transition from an unloaded state to a loaded state as part of a UE handover process. In an aspect, the cell may receive, from a loaded cell, a request for a UE to handover to the cell based on a first PCI signal, transmit the second PCI signal, and support the UE using the second PCI signal. In such an aspect, the cell may then ramp downwards power associated with signals from the first PCI. In an aspect, transmission of the second PCI signal may be started based on the receiving the request. Further discussion of the handover process is provided with reference to FIG. 4.

Further, with respect to blocks 610 and 612, a cell may transition from an unloaded state to a loaded state as part of a UE connection initiation. For example, the UE may be initiating a connection in cell B, where cell B is currently unloaded. To transition to a loaded state, cell B may change its PCI from x to y.

In an aspect, the PCI change process may include Cell B receiving an access attempt from the UE, accepting the UE access with PCI being PCI x, starting transmitting pilots for PCI y (e.g., with the same power as PCI x), handing over the UE from PCI x to PCI y with a handover command, and allowing the UE to connect to Cell B via PCI y. Thereafter, Cell B may gradually ramps down PCI x to zero power, and ramps up PCI y to normal power.

In another aspect, the PCI change process may include Cell B receiving an access attempt from the UE, starting the access process with PCI being PCI x, commanding the to continue the access process using PCI y, starting transmitting pilots for PCI y (e.g., with the same power as PCI x), and allowing the UE to connect to Cell B via PCI y. Thereafter, Cell B may gradually ramps down PCI x to zero power, and ramps up PCI y to normal power.

In still another aspect, the PCI change process may include Cell B monitors for access on PCI y, even when it is not transmitting PCI y, receiving an access attempt from the UE via PCI y where the UE is configured with a mapping such that it accesses on PCI y when it detects PCI x, starting transmitting pilots for PCI y (e.g., with the same power as PCI x), and allowing the UE to connect to Cell B via PCI y. Thereafter, Cell B may gradually ramps down PCI x to zero power, and ramps up PCI y to normal power.

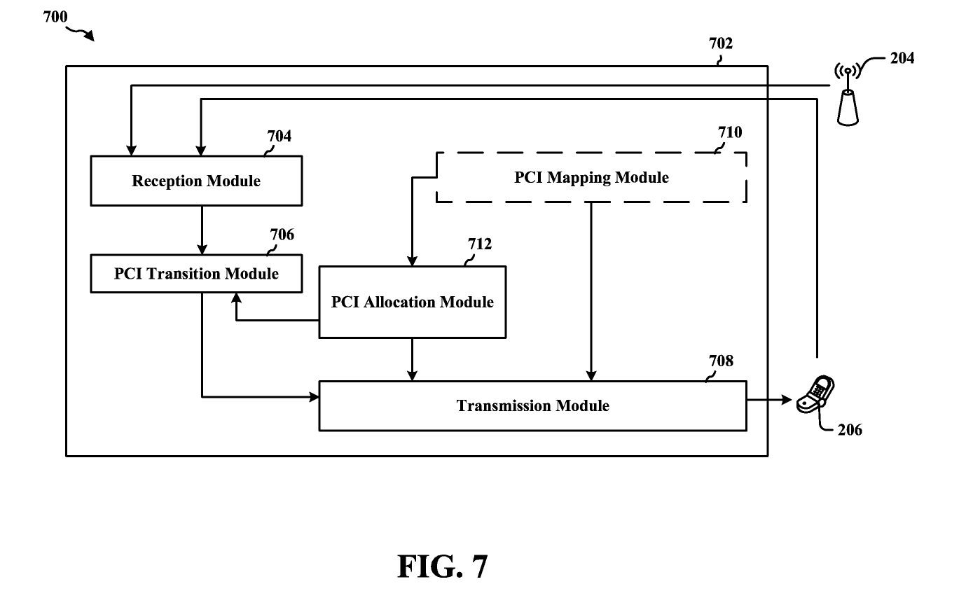

FIG. 7 is a conceptual data flow diagram 700 illustrating the data flow between different modules/means/components in an exemplary apparatus 702. The apparatus may be a network entity, such as but not limited to, an eNB, MME, etc. As noted above with reference to FIGS. 5 and 6, the apparatus includes a reception module 704, a PCI transition module 706, a transmission module 708, a PCI mapping module 710, and a PCI allocation module 712.

In an operational aspect, apparatus 702 PCI allocation module 712 may be configured to determine whether a cell is loaded or unloaded, and may allocate a PCI from a common pool of PCIs to the cell upon a determination that the cell is unloaded. In another aspect, PCI allocation module 712 may allocate a PCI from one of one or more PCI pools to the cell upon a determination that the cell is loaded. In an aspect, PCI allocation module 712 determines that the cell is loaded when one or more UEs 206 are actively supported by the cell, and determines that the cell is unloaded when no UEs 206 are actively supported by the cell. Further, PCI mapping module 710 may map a PCI in each of one or more PCI pools to the PCI for the cell that may be available for the cell if/when the cell is loaded. In an aspect, PCI mapping module 710 may statically and/or dynamically map PCIs.

In another operational aspect, apparatus PCI transition module 706 may be configured to determine that a cell is to transition between an unloaded state and a loaded state, and use a first PCI from a common PCI pool associated with the cell in the unloaded state and a second PCI from one of one or more PCI pools associated with the cell in the loaded state. In an aspect in which PCI transition module 706 determines that the cell is transitioning from an unloaded state to a loaded state, PCI transition module 706 prompts the cell to ramp downwards power associated with transmission of the first PCI, and ramp upwards power associated with transmission of the second PCI. In an aspect in which the apparatus 702 is an eNB, apparatus may receive an access request from a UE 206 via reception module 704, and the transmissions may be performed by transmission module 708. As such, PCI transition module 706 may assist in providing to support transfer of one or more UEs 206 from being supported using the first PCI to being supported using the second PCI. In an aspect, PCI transition module 706 may facilitate the transition by receiving a request for a UE 206 handover to the cell, from another cell 204, based on the first PCI signal. In such an aspect, PCI transition module 706 may prompt to the cell to transmit the second PCI signal and support the UE using the second PCI signal. Further, in such an aspect, the PCI transition module 706 may prompt to the cell to ramp downwards power associated with the first PCI signal. In another aspect, PCI transition module 706 may prompt the cell to accept the UE based on the first PCI, transmit the second PCI, handover the UE to be supported by the second PCI, and ramp down the first PCI signal. In still another aspect, the PCI transition module 706 may prompt the cell to transmit the second PCI signal, initiate an access procedure with the UE based on the first PCI, transmit a message to the UE to continue the access procedure using the second PCI, accept the UE access based on the second PCI, and ramp down the first PCI signal. In yet another aspect, PCI transition module 706 may prompt the cell to monitor, via reception module 704, an access request on the second PCI when the cell is transmitting using the first PCI, receive the access request, transmit the second PCI signal, accept the UE access based on the second PCI, and ramp down the first PCI signal.

The apparatus may include additional modules that perform each of the steps of the algorithm in the aforementioned call flow and/or flow charts of FIGS. 4, 5, and 6. As such, each step in the aforementioned FIGS. 4, 5, and 6 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

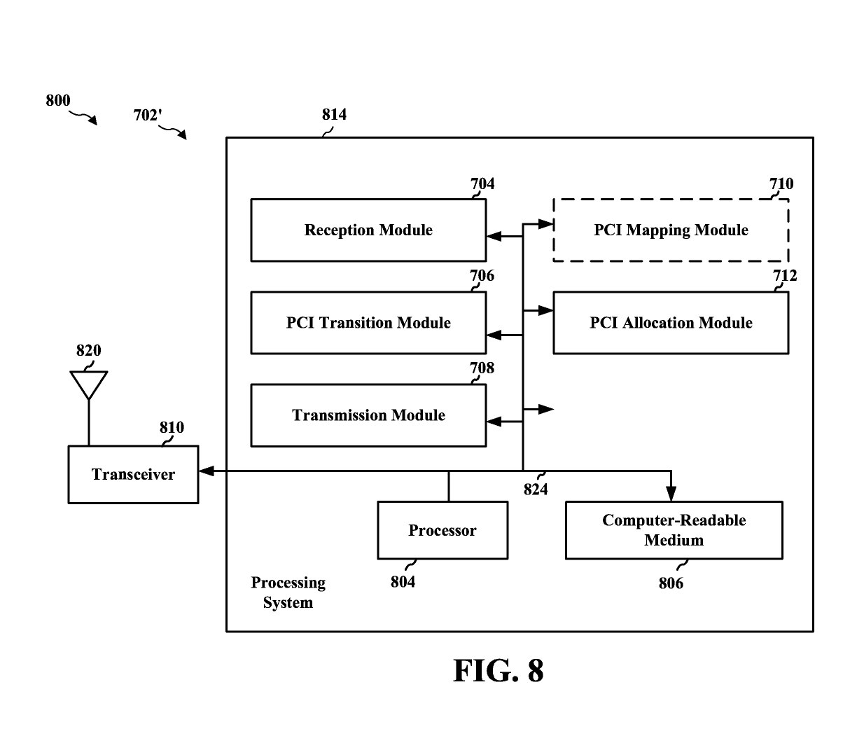

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 804, the modules 704, 706, 708, 710, 712, and the computer-readable medium 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The processing system 814 includes a processor 804 coupled to a computer-readable medium 806. The processor 804 is responsible for general processing, including the execution of software stored on the computer-readable medium 806. The software, when executed by the processor 804, causes the processing system 814 to perform the various functions described supra for any particular apparatus. The computer-readable medium 806 may also be used for storing data that is manipulated by the processor 804 when executing software. The processing system further includes at least one of the modules 704, 706, 708, 710, and 712. The modules may be software modules running in the processor 804, resident/stored in the computer-readable medium 806, one or more hardware modules coupled to the processor 804, or some combination thereof. The processing system 814 may be a component of the network entity 310 and may include the memory 376 and/or at least one of the TX processor 316, the RX processor 370, and the controller/processor 375.

In one configuration, the apparatus 702/702′ for wireless communication includes means for determining whether a cell is loaded or unloaded, and means for allocating a PCI from a common pool of PCIs to the cell upon a determination that the cell is unloaded. In an aspect, apparatus 702/702′ may further provide means for allocating a PCI from one of one or more PCI pools to the cell upon a determination that the cell is loaded. In such an aspect, the one or more PCI pools are different than the common pool of PCIs. In an aspect, apparatus 702/702′ may further provide means for mapping a PCI in each of one or more PCI pools to the PCI for the cell. In such an aspect, the mapped PCI may be available for the cell once the cell is loaded. In an aspect, apparatus 702/702′ may further provide means for selecting PCIs for the common pool of PCIs to be available for unloaded cells, and means for selecting PCIs for one or more PCI pools to be available for loaded cells.

In another configuration, the apparatus 702/702′ for wireless communication includes means for determining that a cell is to transition between an unloaded state and a loaded state, and means for using a first PCI from a common PCI pool associated with the cell in the unloaded state and a second PCI from one of one or more PCI pools associated with the cell in the loaded state. In an aspect, apparatus 702/702′ means for determining may be configured to ramp downwards power associated with signals from the first PCI, and ramp upwards power associated with signals from the second PCI. In an aspect, apparatus 702/702′ may further provide means for providing signaling to support transfer of one or more UEs from being supported using the first PCI to being supported using the second PCI. In an aspect, apparatus 702/702′ means for determining may be configured to receive, from a loaded cell, a request for a UE to handover to the cell based on a first PCI signal, transmit the second PCI signal, support the UE using the second PCI signal. In such an aspect, apparatus 702/702′ may further provide means for ramping downwards power associated with signals from the first PCI. In an aspect, apparatus 702/702′ may provide means for receiving an access request from a UE to access the cell based on the first PCI, means for accepting the UE access based on the first PCI, means for transmitting the second PCI signal, means for handing over the UE from the cell based on the first PCI to the cell based on the second PCI, and means for ramping downwards power associated with signals from the first PCI. In another aspect, apparatus 702/702′ may provide means for receiving an access request from a UE to access the cell based on the first PCI, means for transmitting the second PCI signal, means for initiating an access procedure based on the first PCI, means for transmitting a message to the UE to continue the access procedure using the second PCI, accept the UE access based on the second PCI, and means for ramping downwards power associated with signals from the first PCI. In still another aspect, apparatus 702/702′ may provide means for monitoring for an access request on the second PCI when the cell is transmitting using the first PCI, means for receiving an access request from a UE to access the cell based on the second PCI, mans for transmitting the second PCI signal, means for accepting the UE access based on the second PCI, and means for ramping downwards power associated with signals from the first PCI. In such an aspect, the second PCI may be mapped to the first PCI using a mapping known to the UE.

The aforementioned means may be one or more of the aforementioned modules of the apparatus 702 and/or the processing system 814 of the apparatus 702′ configured to perform the functions recited by the aforementioned means. As described supra, the processing system 814 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

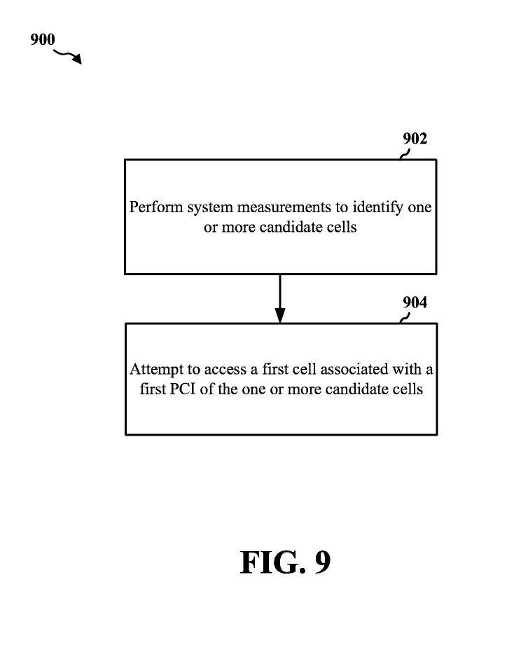

FIG. 9 is a flow chart 900 of a method of wireless communication. The method may be performed by a UE.

At block 902, the UE may perform system measurements to identify one or more candidate cells. In an aspect, a PCI is associated with each of the one or more candidate cells. In an aspect, the measurements may be performed using reception module 1004 and/or measurements module 1006.

At block 904, the UE may attempt to access a first cell associated with a first PCI of the one or more candidate cells. In an aspect, the first PCI may be associated a first PCI pool indicating an unloaded state for the first cell. In an aspect, the accessing may be performed using cell access module 1008, transmission module 1012 and optionally PCI mapping module 1010.

In an aspect, the UE may attempt to access a cell that is in an unloaded state during a handover process. In such an aspect, the cell accessing process may include providing a measurements report, to a serving cell, based on the performed system measurements indicating the first cell with the first PCI of the one or more candidate cells as a handover candidate, receiving a handover command from the serving cell prompting the UE to handover to the first cell with the second PCI, and performing handover to the first cell using the second PCI. Further, in such an aspect, the second PCI may be associated with a second PCI pool and indicates a loaded state for the first cell.

In another aspect, the UE may attempt to access a cell that is in an unloaded state during a connection initiation process. In such an aspect, the accessing process may include the UE transmitting an access request to the first cell based on the first PCI, receiving a message granting the access to the first cell based on the first PCI, performing measurements identifying a second PCI (the second PCI may be associated with a second PCI pool and indicates a loaded state for the first cell), and performing handover to the first cell using the second PCI.

In another aspect, the accessing process may include the UE transmitting an access request to the first cell based on the first PCI, receiving a message prompting the UE to indicate an access procedure to access to the first cell based on the first PCI, receiving a message prompting the UE to continue to access procedure using a second PCI, and accessing the first cell using the second PCI.

In still another aspect, the accessing process may include transmitting an access request to the first cell based on a second PCI, receiving a message granting access to the first cell based on the second PCI, and accessing the first cell using the second PCI. In such an aspect, the second PCI may be associated with a second PCI pool and indicates a loaded state for the first cell, and the second PCI may be mapped to the first PCI using a mapping known to the first cell.

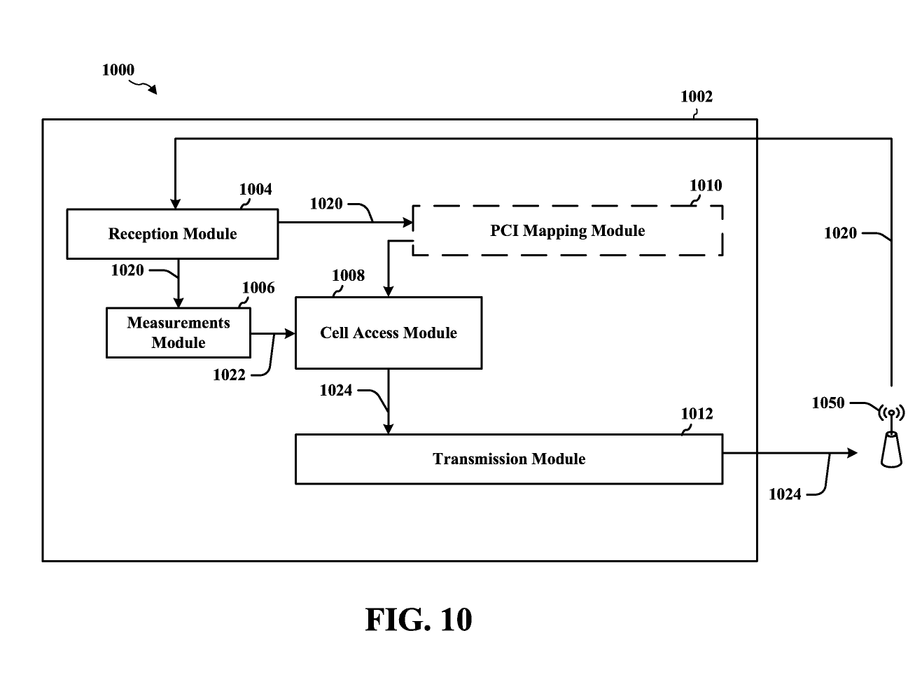

FIG. 10 is a conceptual data flow diagram 1000 illustrating the data flow between different modules/means/components in an exemplary apparatus 1002. The apparatus may be a UE. As noted with reference to FIG. 9, the apparatus includes a reception module 1004, a measurements module 1006, a cell access module 1008, a PCI mapping module 1010, and a transmission module 1012.

In an operational aspect, reception module 1004 may receive signals 1020 from one or more network entities 1050 and provide the signals to measurement module 1006. In an aspect, the received signals may include PCIs associated with each of one or more candidate cells. In another aspect, reception module 1004 may also provide the received signals 1020 to a PCI mapping module 1010. Measurements module 1006 may perform system measurements to identify one or more candidate cells 1022 and provide the candidate cell(s) 1022 information to cell access module 1008. Cell access module 1008 may prepare an access request 1024 based on the candidate cell 1022 information and attempt to access 1024, via transmission module 1012, a first cell associated with a first PCI of the one or more candidate cells.

In an aspect, cell access module 1008 may provide a measurement report 1024 to a serving cell indicating the candidate cell 1022. In such an aspect, reception module 1004 may receive a handover command from the serving cell prompting the apparatus 1002 to handover to the candidate cell, and thereafter apparatus 1002 may perform the handover to the first cell. In such an aspect, the candidate cell may identified in the measurement report 1024 using a first PCI and the handover may occur based on a second PCI.

In another aspect, cell access module 1008 may transmit, via transmission module 1012, an access request 1024 to the first cell based on a first PCI. The reception module 1004 may receive a message granting access to the first cell based on the first PCI. Thereafter, reception module 1004 may perform further measurements and identify a second PCI, and apparatus 1002 may perform a handover to be supported by the second PCI. In another aspect, during the access procedure reception module 1004 may receive a message prompting the apparatus 1002 to continue to access procedure using a second PCI, and cell access module 1008 completes the cell access procedure using the second PCI.

In still another aspect, the cell access module 1008 may transmit, via transmission module 1012, an access request to a first cell based on a second PCI. In such an aspect, PCI mapping module 1010 may provide a mapping between a cell transmitting a first PCI and a second PCI associated with the same cell. The reception module 1004 may receive a message granting access to the first cell based on the second PCI.

The apparatus may include additional modules that perform each of the steps of the algorithm in the aforementioned call flow and/or flow charts of FIGS. 4 and 9. As such, each block in the aforementioned FIGS. 4 and 9 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

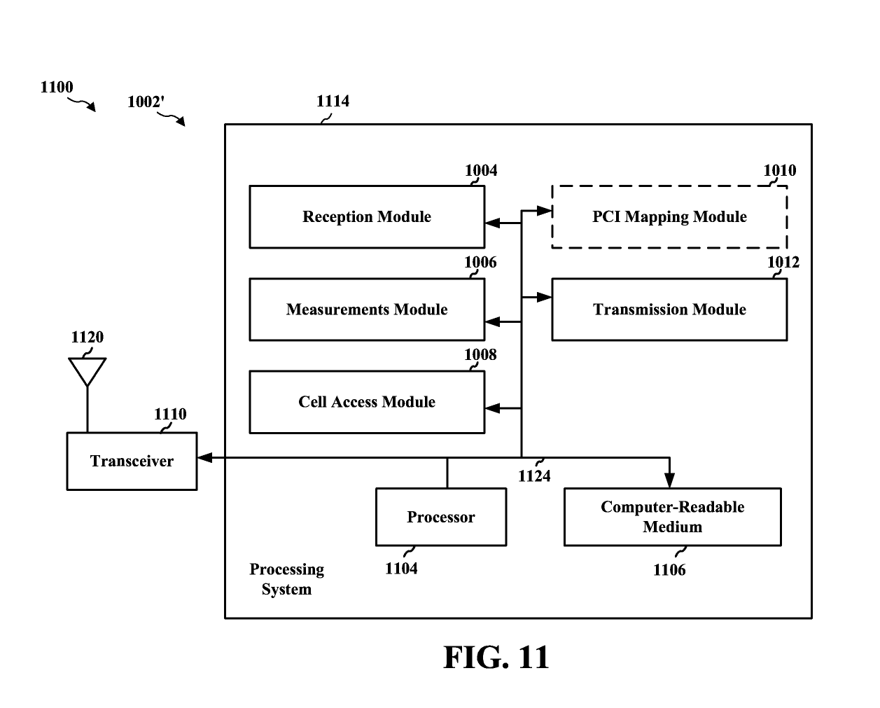

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1104, the modules 1004, 1006, 1008, 1010, 1012, and the computer-readable medium 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The processing system 1114 includes a processor 1104 coupled to a computer-readable medium 1106. The processor 1104 is responsible for general processing, including the execution of software stored on the computer-readable medium 1106. The software, when executed by the processor 1104, causes the processing system 1114 to perform the various functions described supra for any particular apparatus. The computer-readable medium 1106 may also be used for storing data that is manipulated by the processor 1104 when executing software. The processing system further includes at least one of the modules 1004, 1006, 1008, 1010, and 1012. The modules may be software modules running in the processor 1104, resident/stored in the computer-readable medium 1106, one or more hardware modules coupled to the processor 1104, or some combination thereof. The processing system 1114 may be a component of the UE 350 and may include the memory 360 and/or at least one of the TX processor 368, the RX processor 356, and the controller/processor 359.

In one configuration, the apparatus 1002/1002′ for wireless communication includes means for performing system measurements to identify one or more candidate cells, and means for attempting to access a first cell associated with a first PCI of the one or more candidate cells. In an aspect, a physical cell identifier (PCI) is associated with each of the one or more candidate cells and the first PCI is associated a first PCI pool indicating an unloaded state for the first cell. In an aspect, apparatus 1002/1002′ means for attempting to access may be configured to provide a measurements report, to a serving cell, based on the performed system measurements indicating the first cell with the first PCI of the one or more candidate cells as a handover candidate, receive a handover command from the serving cell prompting the UE to handover to the first cell with the second PCI, and perform handover to the first cell using the second PCI. In an aspect, apparatus 1002/1002′ means for attempting to access may be configured to transmit an access request to the first cell based on the first PCI, receive a message granting access to the first cell based on the first PCI, perform measurements identifying a second PCI, and perform handover to the first cell using the second PCI. In an aspect, apparatus 1002/1002′ means for attempting to access may be configured to transmit an access request to the first cell based on the first PCI, receive a message prompting the UE to initiate an access procedure to access to the first cell based on the first PCI, receive another message prompting the UE to continue to access procedure using a second PCI, and access the first cell using the second PCI. In an aspect, apparatus 1002/1002′ means for attempting to access may be configured to transmit an access request to the first cell based on a second PCI, receive a message granting access to the first cell based on the second PCI, and access the first cell using the second PCI. In such an aspect, the second PCI may be mapped to the first PCI using a mapping known to the first cell. Further, in an aspect, the second PCI may be associated with a second PCI pool and indicates a loaded state for the first cell.

The aforementioned means may be one or more of the aforementioned modules of the apparatus 1002 and/or the processing system 1114 of the apparatus 1002′ configured to perform the functions recited by the aforementioned means. As described supra, the processing system 1114 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of communications, comprising:
determining whether a cell is loaded or unloaded; and
allocating a physical cell identifier (PCI) from a common pool of PCIs to the cell upon a determination that the cell is unloaded.

2. The method of claim 1, wherein the common pool of PCIs corresponds to pilots that do not collide with a PCI used by a cell that is determined to be loaded.

3. The method of claim 1, wherein the cell is determined to be loaded when one or more UEs are actively supported by the cell, and wherein the cell is determined to be unloaded when no UEs are actively supported by the cell.

4. The method of claim 1, further comprising:
allocating a PCI from one of one or more PCI pools to the cell upon a determination that the cell is loaded, wherein the one or more PCI pools are different than the common pool of PCIs.

5. The method of claim 4, wherein the one or more PCI pools comprises two PCI pools and wherein the two PCI pools and the common PCI pool are substantially equally sized.

6. The method of claim 1, further comprising:
mapping a PCI in each of one or more PCI pools to the PCI for the cell, wherein the mapped PCI is available for the cell once the cell is loaded.

7. The method of claim 6, wherein the PCI in each of the one or more PCI pools is statically mapped to the PCI for the cell.

8. The method of claim 7, wherein the static mapping includes adding a constant equal to the number of available PCIs in each of the PCI pools to the PCI for the cell.

9. The method of claim 6, wherein the PCI in each of the one or more PCI pools is dynamically mapped to the PCI for the cell based at least in part on PCIs used by one or more neighboring cells.

10. The method of claim 1, wherein the at least one of the determining or the allocating is performed by at least one of an evolved NodeB (eNB), or a mobility management entity (MME).

11. The method of claim 1, further comprising:
selecting PCIs for the common pool of PCIs to be available for unloaded cells; and
selecting PCIs for one or more PCI pools to be available for loaded cells.

12. The method of claim 11, wherein the PCIs are statically selected, and wherein the PCI is allocated based on at least:
which PCI has a minimum energy;
which PCI is below a energy threshold; or
which PCI is at least a threshold distance away from a PCI allocated to a neighboring cell.

13. The method of claim 11, wherein the PCIs are dynamically selected, and wherein the selecting further comprises defining a maximum number of PCIs for the common pool of PCIs.

14. The method of claim 11, wherein the PCIs are dynamically selected, wherein each PCI is assigned an index value, and wherein the PCI is allocated based on at least:
which PCI has a minimum energy;
which PCI is below a energy threshold; or
which PCI is at least a threshold distance away from a PCI allocated to a neighboring cell.

15. The method of claim 11, wherein the PCIs are dynamically selected, wherein each PCI is assigned an index value, wherein multiple PCIs are available for allocation, and wherein the PCI with the lowest index value is allocated to the unloaded cell.

16. A method of communications, comprising:
determining that a cell is to transition between an unloaded state and a loaded state; and
using a first physical cell identifier (PCI) from a common PCI pool associated with the cell in the unloaded state and a second PCI from one of one or more PCI pools associated with the cell in the loaded state.

17. The method of claim 16, wherein the determined transition is from the unloaded state to the loaded state, further comprising:
ramping downwards power associated with signals from the first PCI; and
ramping upwards power associated with signals from the second PCI.

18. The method of claim 16, wherein the determined transition is from the unloaded state to the loaded state, further comprising:
providing signaling to support transfer of one or more UEs from being supported using the first PCI to being supported using the second PCI.

19. The method of claim 16, wherein the determined transition is from the loaded state to the unloaded state, and wherein the determination is based on a detection that no UEs are actively being served by the cell.

20. The method of claim 16, wherein the determined transition is from the unloaded state to the loaded state, further comprising:
receiving, from a loaded cell, a request for a UE to handover to the cell based on a first PCI signal;
transmitting the second PCI signal; and
supporting the UE using the second PCI signal.

21. The method of claim 20, further comprising:
ramping downwards power associated with signals from the first PCI.

22. The method of claim 20, wherein transmission of the second PCI signal is started based on the receiving the request.

23. The method of claim 16, wherein the determined transition is from the unloaded state to the loaded state, further comprising:
receiving an access request from a UE to access the cell based on the first PCI;
accepting the UE access based on the first PCI;
transmitting the second PCI signal;
handing over the UE from the cell based on the first PCI to the cell based on the second PCI; and
ramping downwards power associated with signals from the first PCI.

24. The method of claim 16, wherein the determined transition is from the unloaded state to the loaded state, further comprising:
receiving an access request from a UE to access the cell based on the first PCI;
transmitting the second PCI signal;
initiating an access procedure based on the first PCI;
transmitting a message to the UE to continue the access procedure using the second PCI;
accepting the UE access based on the second PCI; and
ramping downwards power associated with signals from the first PCI.

25. The method of claim 16, wherein the determined transition is from the unloaded state to the loaded state, further comprising:
monitoring for an access request on the second PCI from a UE when the cell is transmitting using the first PCI, wherein the second PCI is mapped to the first PCI using a mapping known to the UE;
receiving the access request from the UE to access the cell based on the second PCI;
transmitting the second PCI signal;
accepting the UE access based on the second PCI; and
ramping downwards power associated with signals from the first PCI.

26. A method of wireless communications for a user equipment (UE), comprising:
performing system measurements to identify one or more candidate cells, wherein a physical cell identifier (PCI) is associated with each of the one or more candidate cells; and
attempting to access a first cell associated with a first PCI of the one or more candidate cells, wherein the first PCI is associated a first PCI pool indicating an unloaded state for the first cell.

27. The method of claim 26, wherein the attempting to access the first cell further comprises:
providing a measurements report, to a serving cell, based on the performed system measurements indicating the first cell with the first PCI of the one or more candidate cells as a handover candidate;
receiving a handover command from the serving cell prompting the UE to handover to the first cell with the second PCI, wherein the second PCI is associated with a second PCI pool and indicates a loaded state for the first cell; and
performing handover to the first cell using the second PCI.

28. The method of claim 26, wherein the attempting to access the first cell further comprises:
transmitting an access request to the first cell based on the first PCI;
receiving a message granting access to the first cell based on the first PCI;
performing measurements identifying a second PCI, wherein the second PCI is associated with a second PCI pool and indicates a loaded state for the first cell; and
performing handover to the first cell using the second PCI.

29. The method of claim 26, wherein the attempting to access the first cell further comprises:
transmitting an access request to the first cell based on the first PCI;
receiving a first message prompting the UE to initiate an access procedure to access to the first cell based on the first PCI;
receiving a second message prompting the UE to continue to the access procedure using a second PCI, wherein the second PCI is associated with a second PCI pool and indicates a loaded state for the first cell; and
accessing the first cell using the second PCI.

30. The method of claim 26, wherein the attempting to access the first cell further comprises:
transmitting an access request to the first cell based on a second PCI, wherein the second PCI is associated with a second PCI pool and indicates a loaded state for the first cell, and wherein the second PCI is mapped to the first PCI using a mapping known to the first cell;
receiving a message granting access to the first cell based on the second PCI; and
accessing the first cell using the second PCI.

31. An apparatus for communications, comprising:
means for determining whether a cell is loaded or unloaded; and
means for allocating a physical cell identifier (PCI) from a common pool of PCIs to the cell upon a determination that the cell is unloaded.

32. An apparatus for communications, comprising:
means for determining that a cell is to transition between an unloaded state and a loaded state; and
means for using a first physical cell identifier (PCI) from a common PCI pool associated with the cell in the unloaded state and a second PCI from one of one or more PCI pools associated with the cell in the loaded state.

33. An apparatus for wireless communications by a user equipment (UE), comprising:
means for performing system measurements to identify one or more candidate cells, wherein a physical cell identifier (PCI) is associated with each of the one or more candidate cells; and
means for attempting to access a first cell associated with a first PCI of the one or more candidate cells, wherein the first PCI is associated a first PCI pool indicating an unloaded state for the first cell.

34. A computer program product, comprising:
a computer-readable medium comprising code for:
determining whether a cell is loaded or unloaded; and
allocating a physical cell identifier (PCI) from a common pool of PCIs to the cell upon a determination that the cell is unloaded.

35. A computer program product, comprising:
a computer-readable medium comprising code for:
determining that a cell is to transition between an unloaded state and a loaded state; and
using a first physical cell identifier (PCI) from a common PCI pool associated with the cell in the unloaded state and a second PCI from one of one or more PCI pools associated with the cell in the loaded state.

36. A computer program product, comprising:
a computer-readable medium comprising code for:
performing, by a user equipment (UE), system measurements to identify one or more candidate cells, wherein a physical cell identifier (PCI) is associated with each of the one or more candidate cells; and
attempting to access a first cell associated with a first PCI of the one or more candidate cells, wherein the first PCI is associated a first PCI pool indicating an unloaded state for the first cell.

37. An apparatus for communications, comprising:
a processing system configured to:
determine whether a cell is loaded or unloaded; and
allocate a physical cell identifier (PCI) from a common pool of PCIs to the cell upon a determination that the cell is unloaded.

38. The apparatus of claim 37, wherein the common pool of PCIs corresponds to pilots that do not collide with a PCI used by a cell that is determined to be loaded.

39. The apparatus of claim 37, wherein the cell is determined to be loaded when one or more UEs are actively supported by the cell, and wherein the cell is determined to be unloaded when no UEs are actively supported by the cell.

40. The apparatus of claim 37, wherein the processing system is further configured to:
allocate a PCI from one of one or more PCI pools to the cell upon a determination that the cell is loaded, wherein the one or more PCI pools are different than the common pool of PCIs.

41. The apparatus of claim 40, wherein the one or more PCI pools comprises two PCI pools and wherein the two PCI pools and the common PCI pool are substantially equally sized.

42. The apparatus of claim 37, wherein the processing system is further configured to:
map a PCI in each of one or more PCI pools to the PCI for the cell, wherein the mapped PCI is available for the cell once the cell is loaded.

43. The apparatus of claim 42, wherein the PCI in each of the one or more PCI pools is statically mapped to the PCI for the cell.

44. The apparatus of claim 43, wherein the static mapping includes adding a constant equal to the number of available PCIs in each of the PCI pools to the PCI for the cell.

45. The apparatus of claim 42, wherein the PCI in each of the one or more PCI pools is dynamically mapped to the PCI for the cell based at least in part on PCIs used by one or more neighboring cells.

46. The apparatus of claim 37, wherein the at least one of the determining or the allocating is performed by at least one of an evolved NodeB (eNB), or a mobility management entity (MME).

47. The apparatus of claim 37, wherein the processing system is further configured to:
select PCIs for the common pool of PCIs to be available for unloaded cells; and
select PCIs for one or more PCI pools to be available for loaded cells.

48. The apparatus of claim 47, wherein the PCIs are statically selected, and wherein the PCI is allocated based on at least:
which PCI has a minimum energy;
which PCI is below a energy threshold; or
which PCI is at least a threshold distance away from a PCI allocated to a neighboring cell.

49. The apparatus of claim 47, wherein the PCIs are dynamically selected, and wherein the processing system is further configured to define a maximum number of PCIs for the common pool of PCIs.

50. The apparatus of claim 47, wherein the PCIs are dynamically selected, wherein each PCI is assigned an index value, and wherein the PCI is allocated based on at least:
which PCI has a minimum energy;
which PCI is below a energy threshold; or
which PCI is at least a threshold distance away from a PCI allocated to a neighboring cell.

51. The apparatus of claim 47, wherein the PCIs are dynamically selected, wherein each PCI is assigned an index value, wherein multiple PCIs are available for allocation, and wherein the PCI with the lowest index value is allocated to the unloaded cell.

52. An apparatus for communications, comprising:
a processing system configured to:
determine that a cell is to transition between an unloaded state and a loaded state; and
use a first physical cell identifier (PCI) from a common PCI pool associated with the cell in the unloaded state and a second PCI from one of one or more PCI pools associated with the cell in the loaded state.

53. The apparatus of claim 52, wherein the determined transition is from the unloaded state to the loaded state, and wherein the processing system is further configured to:
ramp downwards power associated with signals from the first PCI; and
ramp upwards power associated with signals from the second PCI.

54. The apparatus of claim 52, wherein the determined transition is from the unloaded state to the loaded state, and wherein the processing system is further configured to:
provide signaling to support transfer of one or more UEs from being supported using the first PCI to being supported using the second PCI.

55. The apparatus of claim 52, wherein the determined transition is from the loaded state to the unloaded state, and wherein the determination is based on a detection that no UEs are actively being served by the cell.

56. The apparatus of claim 52, wherein the determined transition is from the unloaded state to the loaded state, and wherein the processing system is further configured to:
receive, from a loaded cell, a request for a UE to handover to the cell based on a first PCI signal;
transmit the second PCI signal; and
support the UE using the second PCI signal.

57. The apparatus of claim 56, wherein the processing system is further configured to:
ramp downwards power associated with signals from the first PCI.

58. The apparatus of claim 56, wherein transmission of the second PCI signal is started based on the receiving the request.

59. The apparatus of claim 52, wherein the determined transition is from the unloaded state to the loaded state, and wherein the processing system is further configured to:
receive an access request from a UE to access the cell based on the first PCI;
accept the UE access based on the first PCI;
transmit the second PCI signal;
hand over the UE from the cell based on the first PCI to the cell based on the second PCI; and
ramp downwards power associated with signals from the first PCI.

60. The apparatus of claim 52, wherein the determined transition is from the unloaded state to the loaded state, and wherein the processing system is further configured to:
receive an access request from a UE to access the cell based on the first PCI;
transmit the second PCI signal;
initiate an access procedure based on the first PCI;
transmit a message to the UE to continue the access procedure using the second PCI;
accept the UE access based on the second PCI; and
ramp downwards power associated with signals from the first PCI.

61. The apparatus of claim 52, wherein the determined transition is from the unloaded state to the loaded state, and wherein the processing system is further configured to:
monitor for an access request on the second PCI from a UE when the cell is transmitting using the first PCI, wherein the second PCI is mapped to the first PCI using a mapping known to the UE;
receive the access request from the UE to access the cell based on the second PCI;
transmit the second PCI signal;
accept the UE access based on the second PCI; and
ramp downwards power associated with signals from the first PCI.

62. An apparatus for communications, comprising:
a processing system configured to:
perform, by a user equipment (UE), system measurements to identify one or more candidate cells, wherein a physical cell identifier (PCI) is associated with each of the one or more candidate cells; and
attempt to access a first cell associated with a first PCI of the one or more candidate cells, wherein the first PCI is associated a first PCI pool indicating an unloaded state for the first cell.

63. The apparatus of claim 62, wherein the processing system is further configured to:
provide a measurements report, to a serving cell, based on the performed system measurements indicating the first cell with the first PCI of the one or more candidate cells as a handover candidate;
receive a handover command from the serving cell prompting the UE to handover to the first cell with the second PCI, wherein the second PCI is associated with a second PCI pool and indicates a loaded state for the first cell; and
perform handover to the first cell using the second PCI.

64. The apparatus of claim 62, wherein the processing system is further configured to:
transmit an access request to the first cell based on the first PCI;
receive a message granting access to the first cell based on the first PCI;
perform measurements identifying a second PCI, wherein the second PCI is associated with a second PCI pool and indicates a loaded state for the first cell; and
perform handover to the first cell using the second PCI.

65. The apparatus of claim 62, wherein the processing system is further configured to:
transmit an access request to the first cell based on the first PCI;
receive a first message prompting the UE to initiate an access procedure to access to the first cell based on the first PCI;
receive a second message prompting the UE to continue to the access procedure using a second PCI, wherein the second PCI is associated with a second PCI pool and indicates a loaded state for the first cell; and
access the first cell using the second PCI.

66. The apparatus of claim 62, wherein the processing system is further configured to:
transmit an access request to the first cell based on a second PCI, wherein the second PCI is associated with a second PCI pool and indicates a loaded state for the first cell, and wherein the second PCI is mapped to the first PCI using a mapping known to the first cell;
receive a message granting access to the first cell based on the second PCI; and
access the first cell using the second PCI.
